(19) United States
(12) Patent Application Publication
(10) Pub. No.: US 2005/0214068 A1
(43) Pub. Date: Sep. 29, 2005

(54) Joining device

(75) Inventor: Hideo Ito, Tokorozawa-shi (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: PIONEER CORPORATION, Tokyo (JP)

(21) Appl. No.: 11/048,060

(22) Filed: Feb. 2, 2005

(30) Foreign Application Priority Data
Feb. 4, 2004 (JP) 2004-028094

(51) Int. Cl. F16B 21/00

(52) U.S. Cl. 403/326

(57) ABSTRACT

A rib portion (125) constituting a joining device is provided at an upper side plate portion (122) of an upper case of a disc apparatus. At a lower side plate portion (132) of a lower case to be attached to the upper case, an engagement portion (136) constituting the joining device is provided to bias the upper side plate portion (122) in the direction of contacting the upper side plate portion (122) and the lower side plate portion (132) by engaging a rib portion (125). As such, a simple constitution of merely engaging the rib portion (125) and the engagement portion (136) with each other to attach the upper case to the lower case enables the plate portion (122) to be biased in the direction of providing the contacting of the upper side plate portion (122) and the lower side plate portion (132), so as to allow facilitating the contacting of the upper side plate portion (122) and the lower side plate portion (132).

### BACKGROUND OF THE INVENTION

1. Field of the Invention

The present invention relates to a joining device having a first and a second member to be attached by means of an attachment member, and a disc apparatus equipped with the joining device.

2. Description of Related Art

Conventionally, there has been widely used a disc apparatus which reproduces or records/ reproduces optical discs such as DVDs (Digital Versatile Disks) or CDs (Compact Discs). As such a disc apparatus there is known a constitution shown in FIG. 1 and FIGS. 2A and 2B.

A disc apparatus 800 shown in FIG. 1 and FIGS. 2A and 2B has a metal case body 810. The metal case body 810 has an upper case 820, which is open across its lower and front faces, a lower case 830 to cover the lower face of the upper case 820 and a decorative plate 840 to cover the front face of the upper case 820.

The upper case 820 is formed by a rectangular and tabular top plate portion 821; upper side plate portions 822 formed, and bent approximately perpendicularly, on both of the longitudinal edges of the top plate portion 821, respectively; and an upper end plate portion (not shown) formed at the longitudinal edge of the top plate portion 821 and bent approximately perpendicularly in the same direction as the upper side plate portion 822. Here, the upper case 820 is open at its lower and front faces. At the lower edge 822A of the upper side plate portion 822 of the upper case 820 there are provided a plurality of attachment piece portions 823 being cut, and raised inward approximately orthogonally, at a plurality of, e.g. two, locations and having a threaded hole (not shown) drilled therein. Between each of these attachment piece potions 823 is provided a rib portion 825 formed by cutting a tongue shape. This rib portion 825 is of a generally rectangular shape. The rib portion 825 has a continuous portion 826 continuous with the upper side plate portion 822 on the proximal side. At the front end of the continuous portion 826 is provided with a continuous flange portion 827 bent downward in such a way as to form approximately a right angle with respect to the upper side plate portion 822. Further, at the front end of the rib contact portion 828 is provided with a front end portion 829 bent inward in such a way as to form an obtuse angle with respect to the rib contact portion 828.

The lower case 830 is formed by a rectangular and flat bottom plate portion 831 being of the substantially same shape as the top plate portion 821 of the upper case 820; a lower side plate portion 832 formed at both of the longitudinal edges of the bottom plate portion 831 and bent approximately perpendicularly; and a lower end plate portion 833 formed on one longitudinal edge of the bottom plate portion 831 and bent approximately perpendicularly in the same direction as the lower side plate portion 832. Here, the lower case 830 is open at its upper and front faces. At the bottom plate portion 831 of the lower case 830 is provided with an attachment dowel 834 having therein a threaded hole 835 and being bent in such a way as to bulge out upward corresponding to the attachment piece portion 823 of the upper side plate portion 822. At the lower side plate portion 832 of the lower case 830 there is provided an engagement portion 836 bent in such a way as to expand out outward corresponding to the rib portion 825 of the top plate portion 821. The engagement portion 836 has an engagement contact portion 838 disposed approximately in the middle seen in the direction of right and left such that an inner face 838A is approximately parallel to an outer face 832A of the lower side plate portion 832. The engagement portion 836 has a connection portion 837 for connecting the lower side plate portion 832 and the engagement contact portion 838 with each other, where the connection portion 837 is disposed on both of the end sides seen in the direction of right and left in such a way as to slope with respect to the outer face 832A of the lower side plate portion 832. The engagement portion 836 is disposed such that assembling of the upper case 820 onto lower case 830 causes the rib contact portion 828 of the rib portion 825 of the upper case 820 to be positioned on the side of the inner face 838A of the engagement contact portion 838.

The decorative plate 840 is of a generally tabular shape, made of synthetic resin such as Acrylonitrile-Butadiene-Styrene (ABS), etc.

Inside the case body 810, as shown in FIG. 1, there is disposed a frame body 850 made of synthetic resin such as ABS and shaped as a generally square frame open at both of its end faces seen in the axial direction. The frame body 850 is provided therein with a body portion 860 having a base 861 shaped as, for example, a tabular frame made of metal. The base 861 has one edge integrally attached to a rotation guide portion 862. The base 861 is rotationally guided by the rotation guide portion 862. The base 861 is provided therein with a disc rotation drive 870 having an electric motor for rotation such as a spindle motor and a turntable 871 provided integrally on an output axis (not shown) of the electric motor for rotation. The base 861 further is provided therein with a moving member 880 provided with a pair of guide shafts 881 and an electric motor 882 for movement.

The moving member 880 is provided therein with a playback member 890. The playback member 890 is held in such a way as to bridge over the pair of guide shafts 881, and has a movement holding portion 892 (not shown) being equipped with a light source (not shown), a lens 891 to converge light beams from the light source, and an optical sensor (not shown) to detect light beams reflected from an optical disc D.

The frame body 850 is provided therein with a rotator support member 900 shaped, for example, as a metal plate and threadably secured. The rotator support member 900 is provided therein with a concave support recess 901 facing upward and disposed approximately in the middle at a position opposite the turntable 871 of the disc rotation drive 870. The support recess 901 has a support hole 902 with an opening defined approximately in its middle. The support recess 901 of the rotator support member 900 has a rotator 903 placed rotatably thereon.

On the other hand, the frame body 850 is provided therein with a disc tray 910 shaped as, for example, a plate made of synthetic resin and advance- and retractable horizontally.

The frame body 850 further is provided therein with an opening and closing drive 920 for moving the disc tray 910. The opening and closing drive 920 has, among others, a moving cum 921 for rotating the base 861 upward and downward, disposed movable in the direction orthogonal to the longitudinal direction of the frame body 850.

The body portion 860 is constituted by the above-described disc rotation drive 870, the moving member 880, the playback member 890 and the opening and closing drive 920.

To the frame body 850 is attached a circuit board 930 having a tabular shape approximately the size of the lower case 830 of the case body 810. The circuit board 930 has a control circuit (not shown) mounted thereon having an electric part (not shown) to control the operations of the body portion 860. The circuit board 930 is provided therein with a connector portion 931 detachably connected with a power cable (not shown) or cables for receiving/transmitting signals to a variety of external electric machines (not shown). The connector portion 931 is disposed in such a way as to face the exterior from the case body 810.

When assembling the disc apparatus 800, this causes the upper case 820 to be threadably secured to the lower case 830 having provided therein each of the above-described members, such that the rib contact portion 828 of the rib portion 825 is positioned on the side of the inner face 838A of the engagement contact portion 838. As such, the contacting of the rib contact portion 828 and the engagement contact portion 838 of the engagement portion 836 with each other enables restriction of the outward movement of the rib portion 825 and also restriction of the outward movement of the upper side plate portion 822, even when, for example, the upper side plate portion 822, which is movable in the direction intersecting the attachment direction of the upper case 820, is deformed and so moved outward.

The conventional disc apparatus 800 as shown in FIG. 1 and FIGS. 2A and 2B is desirably constituted such that, from the standpoint of good appearance and the like, attachment of the upper case 820 to the lower case 830 be done with the width X of the gap S between the upper and lower side plate portions 822 and 832 being zero. However, in order to make the width X zero, dimensional tolerances of, for example, the rib portion 825 and the engagement portion 836 need to be strictly controlled. This creates a problem of cumbersome and complicated manufacture of the upper and lower cases 820 and 830, to mention one example.

### SUMMARY OF THE INVENTION

An object of the present invention is to provide a joining device allowing the contacting of vicinities of free ends of a first and a second member to be facilitated.

According to one aspect of the present invention, a joining device having a first and a second member to be attached by means of an attachment member, respective vicinities of movable free ends of the first and the second members being contacted with each other, includes: an engagement portion provided on one of the first and the second members; and a lock portion for biasing at least one of the vicinities of the free ends of the first and the second members, through engagement with the engagement portion, in the direction of contacting with each other, the lock portion being provided at the other one of the first and the second members.

According to another aspect of the present invention, a joining device having a first member and a second member to be attached by means of an attachment member, respective vicinities of free ends, which are movable in the direction intersecting an attachment direction, of the first and the second members being contacted with each other, includes: an engagement portion provided at one of the vicinities of the free ends of the first and the second members; and a lock portion for engaging with the engagement portion, the lock portion being provided at the other one of the vicinities of the free ends of the first and the second members; and at least one of the engagement portion and the lock portion is provided with a slope portion sloping with respect to the direction of the engaging and the direction of the contacting.

### BRIEF DESCRIPTION OF THE DRAWINGS

FIG. 1 is an exploded perspective view of a schematic constitution of a conventional disc apparatus;

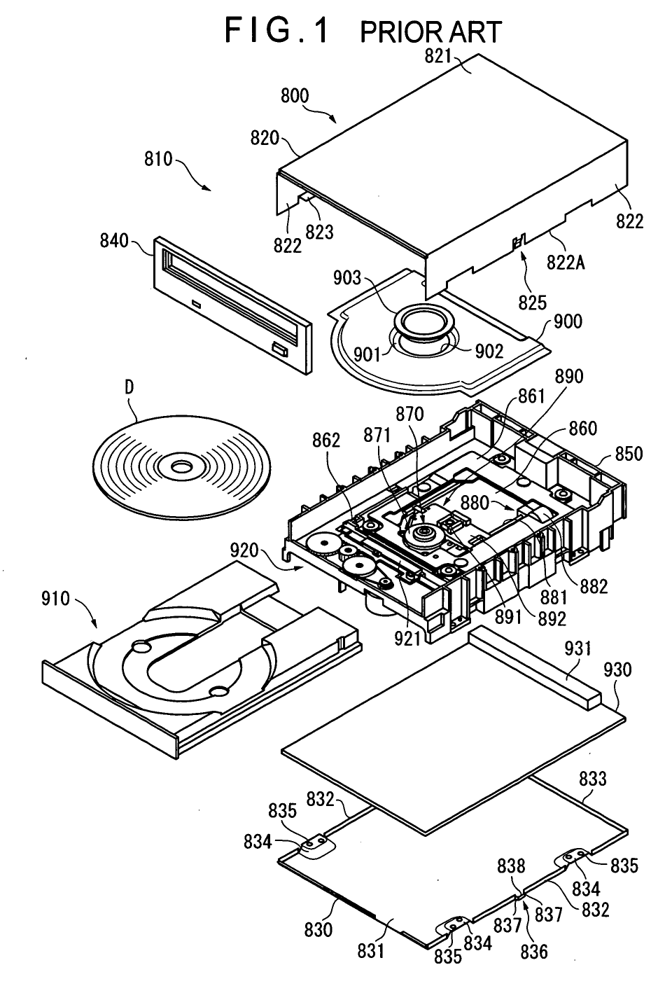

FIGS. 2A and 2B are schematic diagrams showing a schematic constitution of a rib portion and an engagement portion in the conventional disc apparatus, wherein FIG. 2A is a front view and FIG. 2B is a sectional view;

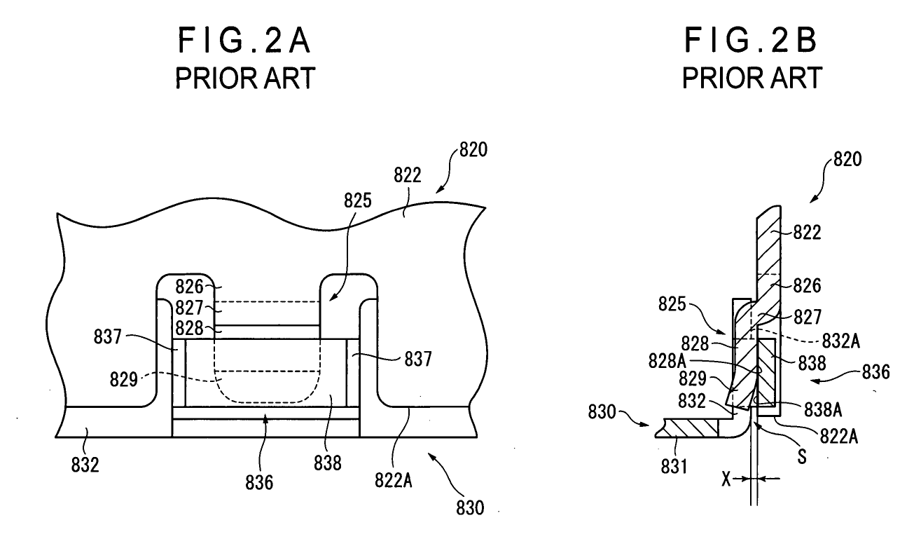

FIG. 3 is an exploded perspective view showing a schematic constitution of a disc apparatus according to a first embodiment of the present invention;

FIGS. 4A and 4B are schematic diagrams showing a schematic constitution of the rib portion in the first embodiment, wherein FIG. 4A is a front view and FIG. 4B is a sectional view;

FIGS. 5A and 5B are schematic diagrams showing a schematic constitution of the engagement portion in the first embodiment, wherein FIG. 5A is a front view and FIG. 5B is a sectional view;

FIGS. 6A and 6B are schematic diagrams showing the state of engagement between the rib portion and the engagement portion in the first embodiment, wherein FIG. 6A is a front view and FIG. 6B is a sectional view;

FIG. 7 is a view schematically showing the state of attachment of an upper case and a lower case to each other in the first embodiment;

FIG. 8 is a view schematically showing the effects of the first embodiment;

FIGS. 9A and 9B are schematic diagrams showing a schematic constitution of a rib portion and an engagement portion of a disc apparatus according to a second embodiment of the present invention, wherein FIG. 9A is a front view and FIG. 9 is a sectional view;

FIGS. 10A and 10B are schematic diagrams showing a schematic constitution of a rib portion and an engagement portion of a disc apparatus according to still another embodiment of the present invention, wherein FIG. 10A is a front view and FIG. 10B is a sectional view;

FIGS. 11A and 11B are schematic diagrams showing a schematic constitution of a rib portion and engagement portion of a disc apparatus according to yet another embodiment of the present invention, wherein FIG. 11A is a front view and FIG. 11B is a bottom view; and

FIGS. 12A and 12B are schematic diagrams showing a schematic constitution of a rib portion and an engagement portion of a disc apparatus according to yet another embodiment of the present invention, wherein FIG. 12A is a front view and FIG. 12B is a bottom view.

### DETAILED DESCRIPTION OF PREFERRED EMBODIMENT(S)

[First Embodiment]

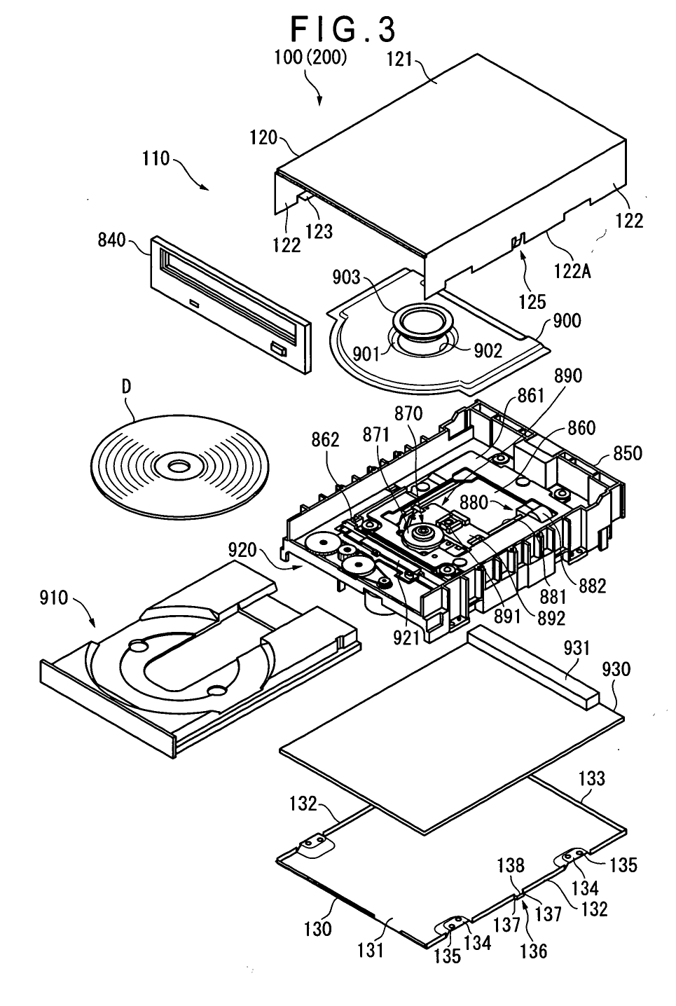

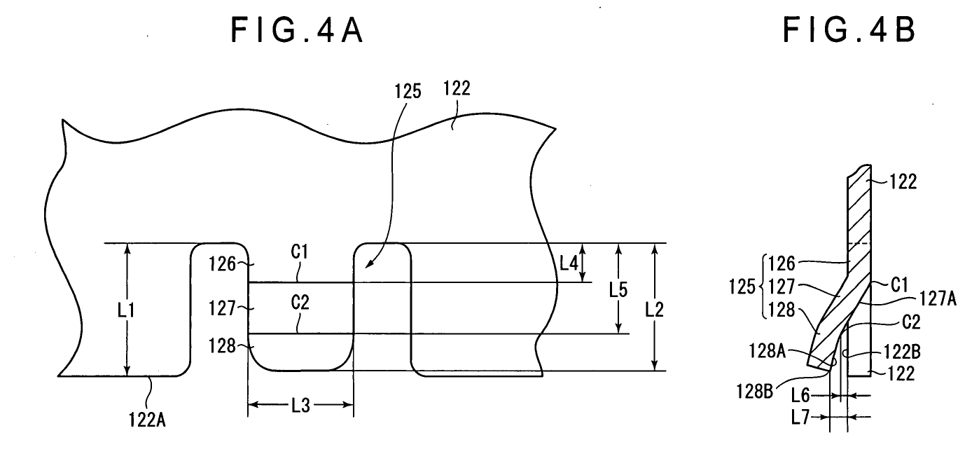

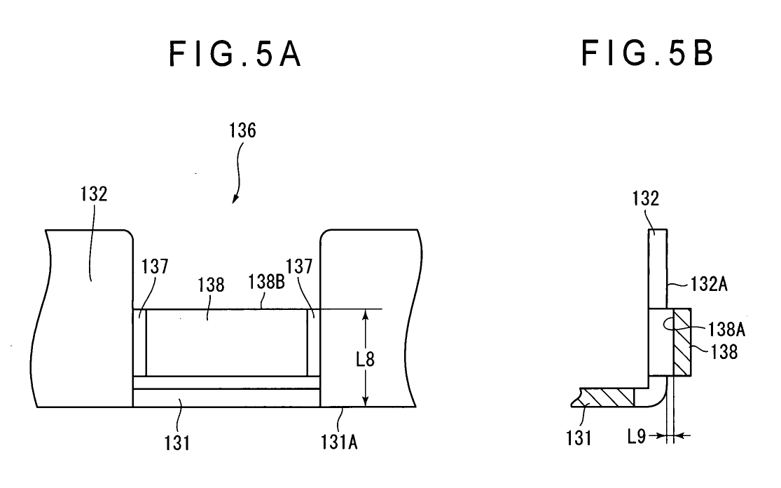

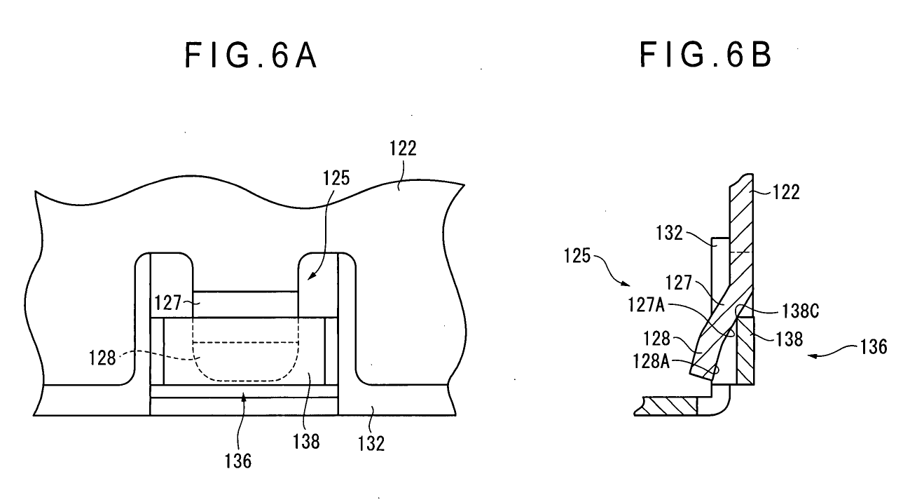

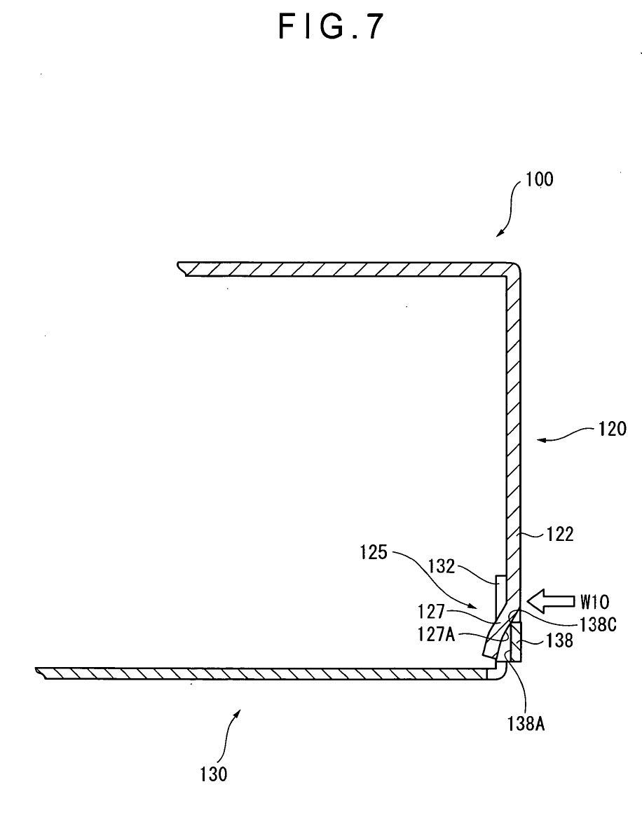

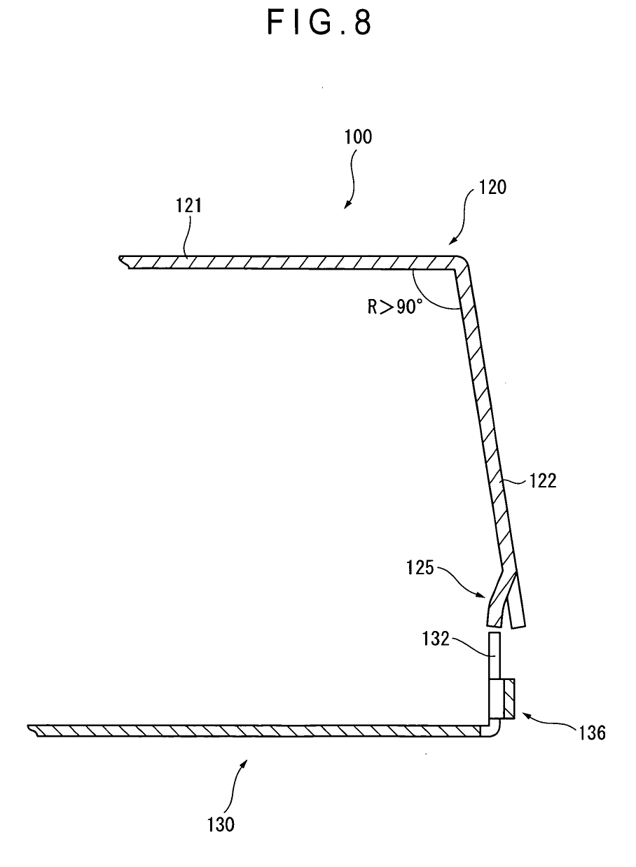

A first embodiment of the present invention will be described below with reference to the accompanying drawings. According to the present embodiment, a disc apparatus is described by way of an example, and explanation will be given about an exemplary configuration, which has a joining device of the present invention applied to a case body of a conventional disc apparatus, however, the present invention is not limited to this embodiment. FIG. 3 is an exploded perspective view of a schematic constitution of the disc apparatus. FIGS. 4A and 4B are respectively a schema of a schematic constitution of a rib portion. FIG. 4A is a front view and FIG. 4B a sectional view. FIGS. 5A and 5B are respectively a front view and a sectional view, both showing schematically constitution of an engagement portion. FIGS. 6A and 6B are respectively a front view and a sectional view, both showing schematically the state of engagement between the rib portion and the engagement portion. FIG. 7 is a view showing schematically the state of attachment of an upper and a lower case to each other. FIG. 8 is a view showing schematically the effects of the present embodiment. Since the disc apparatus of the present embodiment differs from the conventional disc apparatus 800 in the constitution of its case body, the same constitutional requirements as those of the conventional disc apparatus 800 are denoted with the same reference notation and described in a simplified manner.

[Constitution of Disc Apparatus]

Referring to FIG. 3, the reference numeral 100 denotes a disc apparatus. The disc apparatus 100 has a case body 110 formed by an electrically conductive material such as metal. The case body 110 has an upper case 120 as a first case corresponding to a first member open across its lower and front faces, a lower case 130 as a second case to cover the lower face of the upper case 120 and corresponding to a second member attached to with the upper case 120, and a decorative plate 840 to cover the front face of the upper case 120.

The upper case 120 is formed by a rectangular and tabular top plate portion 121; upper side plate portions 122 formed on, and bent at, both of the longitudinal side edges of the top plate portion 121; and an upper end plate portion (not shown) formed on one longitudinal edge of the top plate portion 121 and bent approximately perpendicularly in the same direction as that of the upper side plate portion 122 as the vicinity of a free end. Here, the upper case 120 is open at its lower and front faces. A lower edge 122A, as a free end, of the upper side plate portion 122 of the upper case 120 is provided with an attachment piece portions 123. The attachment piece portions 123 each are, approximately in its middle, provided with a rib portion 125 as a lock portion elastically deformable constituting a joining device and formed by cutting a tongue shape. Here, a constitution of the rib portion 125 cut and bent from the upper side plate portion 122 is described by way of example. However, for example, a constitution may be also possible which has the rib portion 125 formed separately from the upper side plate portion 122 and provided at the upper side plate portion 122. Further, a constitution of the rib portion 125 provided at the lower edge 122A is described by way of example. However, the rib portion 125 may be provided on, for example, the upper end side. Further, a constitution may be also possible which has the rib portion 125 not elastically deformable. As shown in FIGS. 4A and 4B, the rib portion 125 is of a generally rectangular shape, where its length in the direction of up and down and that in the direction of right and left are respectively denoted with L2 and L3. The rib portion 125 is configured to have its length, being denoted with L1, from the proximal end of the upper side plate portion 122 connecting with the top plate portion 121 to the lower edge 122A of the upper side plate portion 122.

The rib portion 125 has a continuous portion 126 continuous with the upper side plate portion 122 on the proximal end side. At the front end of the continuous portion 126 there is continuously formed and bent a rib contact portion 127 constituting a sloping portion bent inward at a bend portion C1. At the front end of the rib contact portion 127 there is continuously formed and bent a front end portion 128 whose slope with respect to the upper side plate portion 122 is more gradual than that of the rib contact portion 127, the front end portion 128 constituting a sloping portion bent downward at a bend portion C2. Here, the rib portion 125 has its length from the proximal end of the continuous portion 126 to the bend portion C1 and that from the proximal end of the continuous portion 126 to the bend portion C2 are respectively being denoted with L4 and L5. The rib portion 125 has its length from an inner face 122B of the upper side plate portion 122 to the bend portion C2 and that from the inner face 122B of the upper side plate portion 122 to a corner portion 128B, which is on the side of an outer face 128A of the front end portion 128 being respectively denoted with L6 and L7.

The lower case 130 is, as shown in FIG. 3, formed by a rectangular and tabular bottom plate portion 131 with the substantially same shape as the top plate portion 121 of the upper case 120; a lower side plate portion 132 corresponding to the vicinity of a free end and formed on both of the longitudinal side edges of the bottom plate portion 131 and bent approximately perpendicularly; and a lower end plate portion 133 formed on one longitudinal edge of the bottom plate portion 131 and bent approximately perpendicularly in the same direction as that of the lower side plate portion 132. Here, the lower case 130 is open at its upper and front faces. The bottom plate portion 131 of the lower case 130 is provided with an attachment dowel 134 bent in such a way as to expand out upward corresponding to the attachment piece portion 123 of the upper side plate portion 122 and having a threaded hole 135 drilled in it. The lower side plate portion 132 of the lower case 130 is provided with an engagement portion 136 constituting the joining device and bent in such a way as to expand out outward corresponding to the rib portion 125 of the upper side plate portion 122. Here, the engagement portion 136 is bent such that the lower side plate portion 132 expands out. However, another constitution is also possible which, for example, has the engagement portion 136 formed separately from, and provided at the lower side plate portion 132.

The engagement portion 136 has, as shown in FIGS. 5A and 5B, has a generally rectangular and tabular engagement contact portion 138 disposed approximately in the middle seen in the direction of left and right such that an inner face 138A is approximately parallel to an outer face 132A of the lower side plate portion 132. The engagement portion 136 has a generally rectangular and tabular connection portion 137 connecting the lower side plate portion 132 and the engagement contact portion 138 with each other, where the connection portion 137 is disposed on the side of both ends seen in the direction of left and right and sloping with respect to the outer face 132A of the lower side plate portion 132. That is, the engagement portion 136 has an opening in the engagement contact portion 138 and the connection portion 137, and is of a generally tubular shape with it axial direction approximately parallel to the direction of up and down, that is, the direction of attachment of the upper and lower cases 120 and 130 to each other. Here, the engagement portion 136 has its length from the lower face 131A of the bottom plate portion 131 to the upper end portion 138B of the engagement contact portion 138 being denoted with L8. The engagement portion 136 has its length from the outer face 132A of the lower side plate portion 132 to the inner face 138A of the engagement contact portion 138 being denoted with L9.

Inside the case body 110, as shown in FIG. 3, are disposed a disc rotation drive 870 having an electric motor for rotation (not shown) as a vibratory apparatus and the like; a moving member 880 having an electric motor 882 for movement as a vibratory apparatus and the like, a playback member 890; a body portion 860 constituted by an opening and closing drive 920; a frame body 850; a rotator support member 900; a disc tray 910; a circuit board 930 as an electronic apparatus, etc.

[Assembling Operations of Disc Apparatus]

Next, assembling operations of the disc apparatus 100 is described.

First, when the upper case 120 is moved toward the lower case 130 provided with each of the above-described members, that is, in the attachment direction, this causes the rib portion 125 to contact an upper end corner portion 138C as the opening edge of the engagement contact portion 138 of the engagement portion 136 at the outer face 128A of the front end portion 128. Thereafter, when the upper case 120 is further moved in the attachment direction, that is, when a force is applied onto the upper case 120 in the attachment direction, this causes the rib portion 125 to be applied onto with a down-grade component force along the outer face 128A (referred to as a front-end-portion parallel component force hereinafter) and a down grade component force orthogonal to the outer face 128A (referred to as a front-end-portion vertical component force hereinafter). Then, the front-end-portion parallel component force causes the rib portion 125 to be moved down-grade while maintaining contact with the upper end corner portion 138C at the outer face 128A, and the front-end-portion vertical component force causes the rib portion 125 to press onto the upper end corner portion 138C. The rib portion 125 thus pressing onto the upper end corner portion 138C creates a reaction force against the front-end-portion vertical component force from the upper end corner portion 138C, causing an up-grade force orthogonal to the outer face 128A to be applied onto the rib portion 125. Along with the rib portion 125 moving down-grade, the upper side plate portion 122 connected with the rib portion 125 is guided in such a direction as to contact the lower side plate portion 132. The direction of contacting the lower side plate portion 132 is referred to as a contact direction hereinafter.

Thereafter, when a force is further applied onto the upper case 120 in the attachment direction, this causes the rib portion 125 to be moved down-grade so as to contact in time the upper end corner portion 138C at an outer face 127A of the rib contact portion 127. Thereafter, when a force is applied onto the upper case 120 in the attachment direction, this causes the rib portion 125 to be applied onto with a down-grade component force along the outer face 127A (referred to as a contact-portion parallel component force hereinafter) and a down-grade component force orthogonal to the outer face 127A (referred to as a contact-portion vertical component force hereinafter). Here, the rib contact portion 127 is formed such that its slope with respect to the upper side plate portion 122 is steeper than that of the front end portion 128. As such, in case a force applied onto the upper case 120 is the same, the contact-portion parallel component force is smaller than the front-end-portion parallel component force, and the contact-portion vertical component force lager than the front-end-portion component force.

The rib portion 125 is moved down-grade through the contact-portion parallel component force while maintaining contact with the upper end corner portion 138C at the outer face 127A, and presses onto the upper end corner portion 138C with the contact-portion vertical component force. The rib portion 125 thus pressing onto the upper end corner portion 138C creates an up-grade reaction force, orthogonal to the outer face 127A, against the contact-portion vertical component force from the upper end corner portion 138C, and this up-grade reaction force is applied onto the rib portion 125. Here, as described above, since the contact-portion vertical component force is larger than the front-end-portion vertical component force, the rib portion 125 is elastically deformed in the up-grade direction orthogonal to the outer face 127A. As such, the down-grade movement of the rib portion 125 and the restoring force against the up-grade elastic deformation of the rib portion 125 cause the upper side plate portion 122 to be guided in the contact direction so as to in time contact the lower side plate portion 132, as shown in FIGS. 6A and 6B.

Thereafter, when a force is further applied onto the upper case 120 in the attachment direction, this causes a reaction force against the contact-portion vertical component force from the upper end corner portion 138C to further deform elastically the rib portion 125. On the other hand, the upper side plate portion 122 is biased in the contact direction through the restoring force against the elastic deformation of the rib portion 125. Then, the upper case 120 is, as shown in FIG. 7, threadably secured to the lower case 130 by means of a screw (not shown) serving as an attachment member, after the rib portion 125 and the engagement portion 136 engage each other and then are moved such that the storage space K is substantially defined as a storage space for vibratory apparatuses and a storage space for electronic instruments, both to store various members not shown. This causes the upper side plate portion 122 to be biased in the contact direction with a load W10 through the restoring force against the elastic deformation of the rib portion 125. The load W10 can be appropriately altered by altering the value of each length Ln (where n is any of natural numbers 1-9) described above. Finally, the decorative plate 840 is attached to the upper and lower cases 120 and 130 and the assembling operations of the disc apparatus 100 are completed.

[Effects First Embodiment]

As described above, the first embodiment is such that the rib portion 125 is provided at the upper side plate portion 122 of the upper case 120 of the disc apparatus 100. Further, at the lower side plate portion 132 of the lower case 130 which is to be attached to the upper case 120 is provided the engagement portion 136, which biases the upper side plate portion 122 in the contact direction by engaging the rib portion 125. As such, a simple configuration of providing the rib portion 125 and the engagement portion 136 having the above-described functions respectively at the upper and lower cases 120 and 130, in such a manner as to attach the upper case 120 to the lower case 130, enables the upper side plate portion 122 to be biased in the contact direction and so allows the upper side plate portion 122 to be easily adhered to the lower side plate portion 132.

As shown, for example, in FIG. 8, even in case the angle R between the top plate portion 121 of the upper case 120 and the upper side plate portion 122 is 90 degrees or more, the mere attachment of the upper case 120 to the lower case 130 enables a contact bonding of the upper side plate portion 122 onto the lower side plate portion 132. Therefore, manufacture of the upper case 120 needs not to involve strictly controlling the angle R, allowing an easy manufacture of the upper case 120.

The rib portion 125 and engagement portion 136 is constituted such that when engaging the rib portion 125 and the engagement portion 136 with each other, this causes a reaction force against the contact-portion vertical component force from the engagement portion 136 to be applied onto the rib contact portion 127 of the rib portion 125 in the up-grade direction orthogonal to the outer face 127A. That is, the rib contact portion 127 is constituted in such a way as to slope with respect to the direction of engaging the rib portion 125 and the engagement portion 136 with each other and that of contacting the upper side plate portion 122 and the lower side plate portion 132 with each other. As such, when the above-described reaction force is applied to the rib contact portion 127 at the time of engaging the rib portion 125 and the engagement portion 136 with each other, this causes the upper side plate portion 122 connected to the rib portion 125 to be guided in the contact direction. As such, when the upper case 120 is attached to the lower case 130 with the rib portion 125 and the engagement portion 136 engaging each other, this causes the upper side plate portion 122 to be biased in the contact direction with the load W10. Therefore, a simple constitution of making the rib contact portion 127 of the rib portion 125 slope with respect to the direction of engaging of the rib portion 125 and the engagement portion 136 with each other and that of contacting the upper side plate portion 122 and the lower side plate portion 132 with each other, enables the upper side plate portion 122 to be biased in the contact direction and so allows the upper side plate portion 122 to be easily adhered to the lower side plate portion 132.

It is further constituted such that the rib portion 125 is provided as an elastically deformable one, whose elastic deformation causes the upper side plate portion 122 to be biased in the contact direction. This reduces the work done for engaging the rib portion 125 and the engagement portion 136 with each other, as compared with the rib portion 125 not elastically deformable. This enables the upper side plate portion 122 to be easily adhered to the lower side plate portion 132.

The rib portion 125 is provided at the lower edge 122A of the upper side plate portion 122. This can simplify the step of providing the rib portion 125, as compared with a constitution of providing the rib portion 125 on the upper end side of the upper side plate portion 122.

The way to form the rib portion 125 by cutting a tongue shape allows the rib portion 125 to be formed when, for example, press-molding the upper case 120. This can simplify the step of providing the rib portion 125.

The rib portion 125 is provided approximately in the middle between the two attachment piece portions 123 secured to the lower side plate portion 132. This enables the approximate middle between the two attachment piece portions 123, which are most easily deformable outward in the upper side plate portion 122, to be biased in the contact direction by the rib portion 125. This allows the entire upper side plate portion 122 to be securely adhered to the lower side plate portion 132.

The engagement portion 136 is provided with an opening portion. It is constituted such that the rib portion 125 is inserted into the opening portion of the engagement portion 136, thereby causing the rib portion 125 to be contacted with the upper end corner portion 138C, and then, while keeping this state, the rib portion 125 is engaged. As such, a simple constitution of merely providing an opening portion in the engagement portion 136 enables engaging the engagement portion 136 and the rib portion 125 with each other, allowing simplifying the step of providing the engagement portion 136. Further, since a simple constitution of merely inserting the rib portion 125 into the engagement portion 136 enables engaging the rib portion 125 and the engagement portion 136, the work of engaging both portions with each other is facilitated.

Further, the engagement portion 136 is of a generally tubular shape such that its axial direction is approximately parallel to the direction of attachment of the upper and lower cases 120 and 130 to each other. This can simplify the step of providing the engagement portion 136, as compared with a constitution of shaping the engagement portion 136 otherwise.

Since the engagement portion 136 is bent such that the lower side plate portion 132 expands outward, this allows forming the engagement portion 136 when, for example, press-molding the lower case 130. This can simplify the step of providing the engagement portion 136.

At the front end of the rib contact portion 127 of the rib portion 125 is provided the front end portion 128 whose slope with respect to the upper side plate portion 122 is more gradual than that of the rib contact portion 127. That is, the front end portion 128 is such that, in case a force applied onto the upper case 120 is the same, onto the front end portion 128 is applied a front-end- portion parallel component force which is larger than the contact-portion parallel component force applied onto the rib contact portion 127. This allows the force applied when moving the rib portion 125 along the outer face 128A of the front end portion 128 to be smaller than the force applied when moving along the outer face 127A of the rib contact portion 127. This can reduce the work done for engaging the rib portion 125 and the engagement portion 136 with each other, as compared with the constitution without the front end portion 128, and so allows the upper side plate portion 122 to be easily adhered to the lower side plate portion 132.

At the rib portion 125 are provided the rib contact portion 127 and the front end portion 128, both differing in their slope with respect to the upper side plate portion 122. As such, since the portion as described above is provided at the rib portion 125, which can be worked more easily than the engagement portion 136, manufacturability of the upper and lower cases 120 and 130 is enhanced.

The joining device constituted by the rib portion 125 and engagement portion 136 is applied to the upper case 120 and lower case 130 containing a storage space K substantially defined for storing, for example, the electric motor 882 which vibrates when driven. This allows the upper side plate portion 122 of the upper case 120 to be contact-bonded to the lower side plate portion 132 of the lower case 130 with the load W10. This in turn prevents the lower side plate portion 132 from vacillating with respect to the upper side plate portion 122 of the upper case 120, even when, for example, the vibration of the electric motor 882 driven is transmitted to the lower case 130. This prevents the lower case 130 from vacillating with respect to the upper case 120 that would have been caused by, for example, vibration caused by driving the electric motor 882.

The joining device constituted by the rib portion 125 and the engagement portion 136 is applied to the upper and lower cases 120 and 130 made of electrically conductive material and storing the circuit board 930. This enable the plate portion of the upper case 120 to be press-bonded to the lower side plate portion 132 of the lower case 130 with the load W10, allowing securely obtaining the conduction between the upper case 120 and the lower case 130. Since the appropriate alteration of the value of each length Ln enables the appropriate alteration of the load W10 applied onto the lower side plate portion 132, the conduction between the upper and lower cases 120 and 130 can be securely obtained by increasing the load W10 through alteration of each length Ln, even in case, for example, a coating is formed by means of plating or painting over the upper side plate portion 122 or the lower side plate portion 132 for sake of heat dissipation or damping. Therefore, as the disc apparatus 100 can be provided one that is of high versatility and flexibility and capable of appropriately obtaining an enough shield effect against electromagnetic waves.

[Second Embodiment]

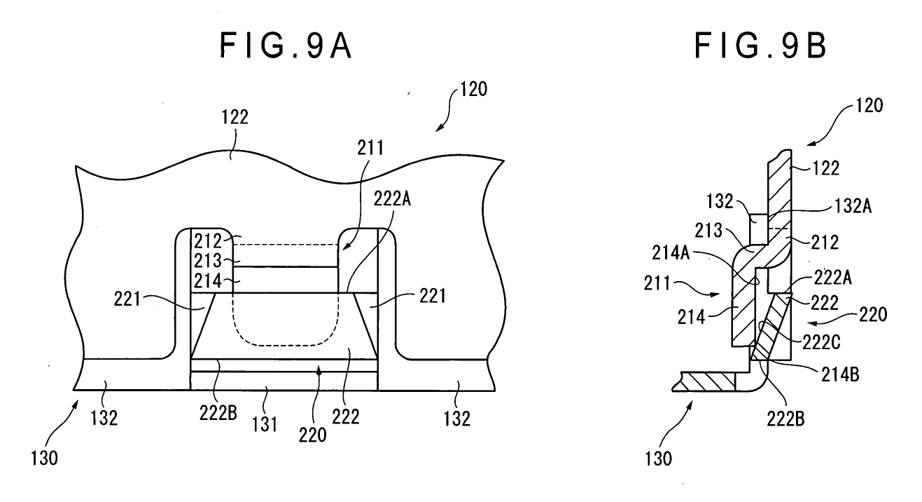

A second embodiment of the present invention will be described below with reference to the accompanying drawings. According to the present embodiment, a disc apparatus 100 is described by way of example, and not intended to be an exclusive example, which is such that the rib portion 125 and the engagement portion 136 of the disc apparatus 100 of the first embodiment are otherwise constituted. FIGS. 9A and 9B are respectively a front view and a sectional view, both a schema of the schematic constitution of the rib portion and engagement portion of the disc apparatus. Since the disc apparatus of the present embodiment differs, as described above, in the constitution of its rib and engagement portions from the disc apparatus 100 of the first embodiment, only a description as to the rib portion and the engagement portion is given below.

[Constitution of Disc Apparatus]

Referring to FIG. 9A, the reference numeral 122 denotes the side plate portion provided at the upper case 120 of the disc apparatus 200 as shown in FIG. 3. At the lower edge 122A of the upper side plate portion 122 is provided a rib portion 211 serving as a lock portion elastically deformable constituting a joining device and formed by cutting a tongue shape. The rib portion 211 has, on its proximal end side, a continuous portion 212 continuous with the upper side plate portion 122. At the front end of the continuous portion 212 is, as shown in FIG. 9B, continuously formed a flange portion 213 bent inward in such a way as to form an angel of approximately 90 degrees with respect to the upper side plate portion 122. At the front end of the flange portion 213 is continuously formed a rib contact portion 214 bent downward in such a way as to form an angle of approximately 90 degrees with respect to the flange portion 213.

On the other hand, at the lower side plate portion 132 of the lower case 130 is provided an engagement portion 220 constituting a joining device and bent in such a way as to expand out outward corresponding to the rib portion 211 of the upper side plate portion 122. The engagement portion 220 has an engagement contact portion 222 representing a generally trapezoidal, tabular slope portion disposed approximately in the middle seen in the direction of right and left and having the upper end portion 222A being shorter than the lower end portion 222B. The engagement contact portion 222 is provided such that the upper end portion 222A is positioned further outward of the lower side plate portion 132 than the lower end portion 222B, that is, that the inner face 222C slopes with respect to the outer face 132A of the lower side plate portion 132. The engagement portion 220 has a generally triangular, tabular connection portion 221 connecting the lower side plate portion 132 and the engagement contact portion 222 with each other and disposed on both of the end sides seen in the crosswise direction in such a way as to slope with respect to the outer face 132A of the lower side plate portion 132.

[Assembling Operations of Disc Apparatus]

Next, the assembling operations of the disc apparatus 200 are described below.

First, facing toward the lower case 130 having disposed therein each member of the upper case 120, the rib portion 211 contacts the inner face 222C of the engagement contact portion 222 of the engagement portion 220 at the lower end corner portion 214B disposed on the side of the outer face 214A of the rib contact portion 214. Thereafter, when a downward force is applied onto the upper case 120, this causes the rib portion 211 to be applied onto with a down-grade component force along the inner face 222C (referred to as a contact-portion parallel component force hereinafter) and a down-grade component force orthogonal to the inner face 222C (referred to as a contact-portion vertical component force). The contact-portion parallel component force then causes the rib portion 211 to be moved down-grade while maintaining contact with the inner face 222C at the lower end corner portion 214B, and the contact-portion vertical component force causes the rib portion 211 to press onto the inner face 222C. The rib portion 211 thus pressing onto the inner face 222C creates a reaction force against the contact-portion vertical component force from the inner face 222C to be applied onto the rib portion 211 in the up-grade direction orthogonal to the inner face 222C. This causes the rib portion 211 to be elastically deformed in the up-grade direction orthogonal to the inner face 222C. As such, the down-grade movement of the rib portion 211 and the restoring force against the up-grade elastic deformation of the rib portion 211 causes the upper side plate portion 122 to be guided in the contact direction so as to in time contact the lower side plate portion 132.

Thereafter, when the force is further applied onto the upper case 120 in the attachment direction, this causes a reaction force against the contact-portion vertical component force from the inner face 222C to further deform elastically the rib portion 211. On the other hand, the upper side plate portion 122 is pressed against the lower side plate portion 132 through the restoring force against the elastic deformation of the rib portion 211. Then, the upper case 120 is threadably secured to the lower case 130 after moving the upper side plate portion 122 as shown in FIG. 7. This restoring force against the elastic deformation of the rib portion 211 causes the upper side plate portion 122 to be biased in the contact direction.

[Effects of Second Embodiment]

As described above, the second embodiment contemplates providing the rib portion 211 at the upper side plate portion 122 of the upper case 120 of the disc apparatus 200, and providing the engagement portion 220, which engages the rib portion 211, at the lower side plate portion 132 of the lower case 130. The rib portion 211 and engagement portion 220 is constituted such that when engaging the rib portion 211 and the engagement portion 220 with each other, this causes the rib portion 211 to be applied onto in the up-grade direction with a contact-portion vertical component force from the engagement contact portion 222. That is, the inner face 222C of the engagement contact portion 222 of the engagement portion 220 is constituted in such a way as to slope with respect to the direction of engaging the rib portion 211 and the engagement portion 220 with each other and to that of contacting the upper side plate portion 122 and the lower side plate portion 132 with each other. As such, the above-described reaction force applied onto the engagement portion 220 at the time of engaging the rib portion 211 and the engagement portion 220 causes the upper side plate portion 122 connected to the rib portion 211 to be guided in the contact direction. Then, when the upper case 120 is attached to the lower case 130 with the rib portion 211 and the engagement portion 220 engaging each other, this causes the upper side plate portion 122 to be biased in the contact direction. Therefore, a simple constitution of making the inner face 222C of the engagement contact portion 222 of the engagement portion 220 merely slope with respect to the direction of engaging the rib portion 211 and the engagement portion 220 with each other and to that of contacting the upper side plate portion 122 and the lower side plate portion 132 each other, enables the upper side plate portion 122 to be easily adhered to the lower side plate portion 132.

Further, it is constituted such that the rib portion 211 is provided as an elastically deformable one, and the restoring force arising when the rib portion 211 is elastically deformed causes the upper side plate portion 122 to be biased in the contact direction. The rib portion 211 is provided at the lower edge 122A of the upper side plate portion 122. The rib portion 211 is formed by cutting a tongue shape. The engagement portion 220 is bent such that the lower side plate portion 132 expands out outward. The joining device constituted by the rib portion 211 and the engagement portion 220 is applied to the upper and lower cases 120 and 130 containing the storage space K substantially defined for storing, for example, the electric motor 882 and the circuit board 930, etc. This allows obtaining the same effects as the first embodiment.

[Variation of Embodiment]

The present invention is not intended to be limited to the above embodiments and to be construed to include variations descried below insofar as the objects of the present invention are achievable.

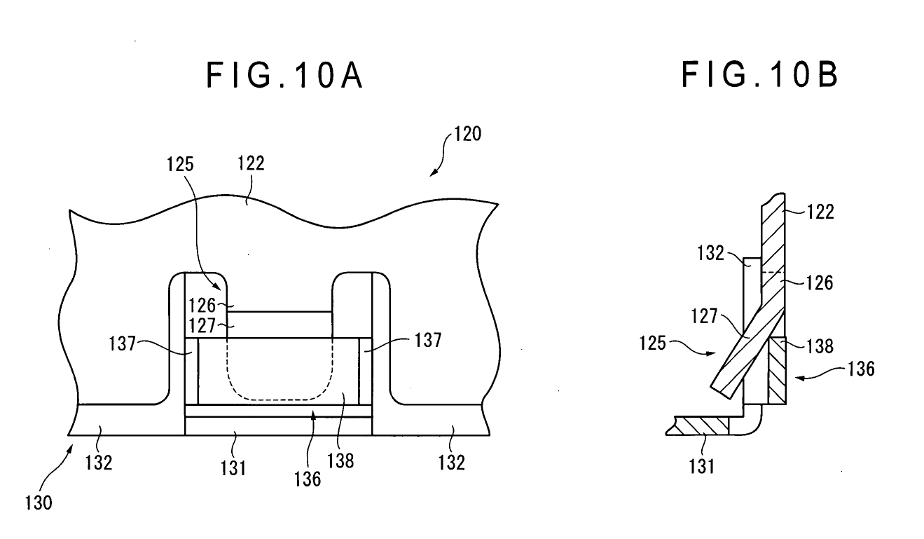

That is, as shown in, for example, FIGS. 10A and 10B, a constitution may be also conceivable of not providing the front end portion 128 at the rib portion 125 of the disc apparatus 100. Such a constitution also can achieve the same effects as those of the first embodiment. This constitution without the front end portion 128 being provided allows the rib portion 125 to be easily molded, as compared with the constitution of the first embodiment, thus enhancing manufacturability of the upper case 120.

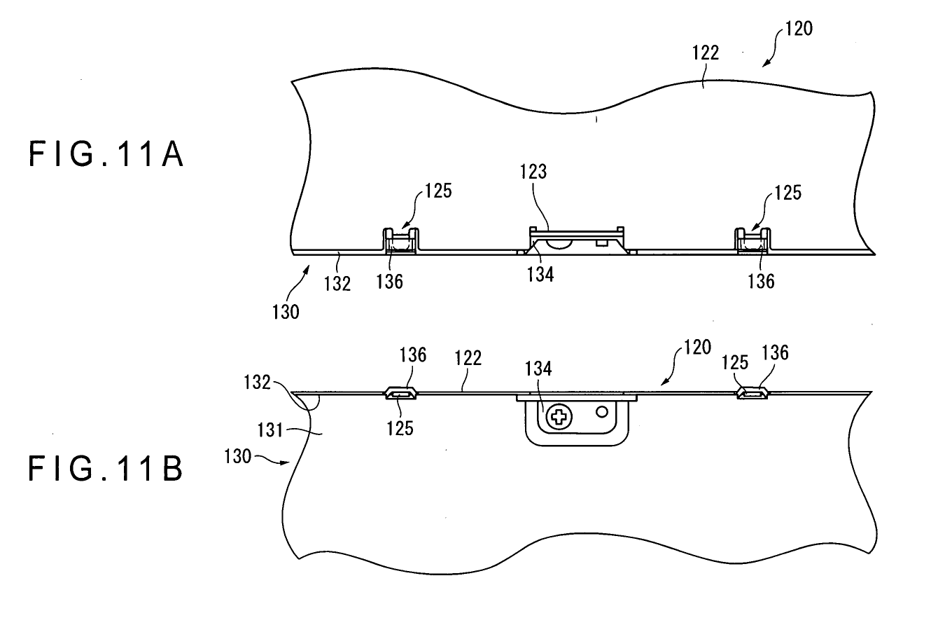

The disc apparatus 100 of the first embodiment may as well be constituted as shown in, for example, FIGS. 11A and 11B. This constitution is such that the rib portion 125 is provided at two locations on the lower edge 122A of the upper side plate portion 122 of the upper case 120. Further, one attachment piece portion 123 is provided between the rib portions 125. The attachment piece portion 123 is positioned such that the rib portion 125 is positioned approximately in the middle between the attachment piece portion 123 and, for example, the side of one longitudinal end of the upper side plate portion 122. On the other hand, an engagement portion 136 is provided, corresponding to the rib portion 125 of the upper side plate portion 122, at the lower side plate portion 132 of the lower case 130. An attachment dowel 134 is provided, corresponding to the attachment piece portion 123 of the upper side plate portion 122, at the bottom plate portion 131 of the lower case 130.

Since with such a constitution, engaging the rib portions 125, provided at two locations, with the engagement portion 136 enables the upper side plate portion 122 to be biased in the contact direction, this allows enhancing adherence between the upper side plate portion 122 and the lower side plate portion 132, as compared with the constitution of the first embodiment, one with the rib portion 125 and the engagement portion 136 being provided. This allows enhancing the shield effect against electromagnetic waves of the disc apparatus 100. Further, the constitution of providing the attachment piece portion 123 and the attachment dowel 134 at one location enables reducing the number of locations for screwing, as compared with the constitution of the first embodiment. This allows easing assembling operations of the disc apparatus 100 and enhancing manufacturability of the disc apparatus 100. Further, since the rib portion 125 is provided approximately in the middle between the attachment piece portion 123 and, for example, the side of one longitudinal end of the upper side plate portion 122, the rib portion 125 can bias the part of being most easily deformable outward in the upper side plate portion 122 in the contact direction. This enables adhering securely the entirety of the upper side plate portion 122 with the lower side plate portion 132.

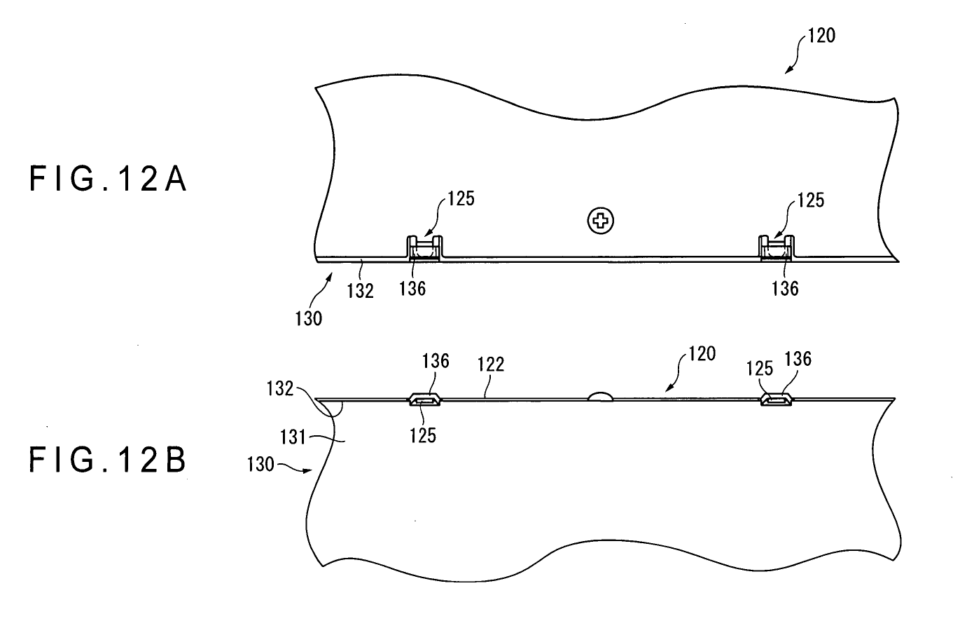

The disc apparatus 100 of the first embodiment may as well be constituted as shown in, for example, FIGS. 12A and 12B. This constitution is such that the rib portion 125 is provided at two locations of the lower edge 122A of the upper side plate portion 122 of the upper case 120 as with the constitution of FIGS. 11A and 11B. A threaded hole (not shown) is drilled between these rib portions 125. Another threaded hole is provided such that the rib portion 125 is positioned approximately in the middle between the former threaded hole and, for example, the side of one longitudinal end of the upper side plate portion 122. On the other hand, an engagement portion 136 is provided corresponding to the rib portion 125 of the upper side plate portion 122. A threaded hole (not shown) is drilled, corresponding to the threaded hole of the upper side plate portion 122, in the lower side plate portion 132 of the lower case 130.

This constitution enables achieving the same effects as those of the constitution of FIGS. 11A and 11B. Further, the constitution of drilling a threaded hole respectively in the upper side plate portion 122 and the lower side plate portion 132 rather than providing the attachment piece portion 123 and the attachment dowel 134, allows the upper and lower cases 120 and 130 to be easily molded, as compared with the constitution of FIGS. 11A and 11B, thereby enhancing manufacturability of these.

The constitutions of FIGS. 11A and 11B and FIGS. 12A and 12 are also applicable to the disc apparatus 200 of the second embodiment.

The joining device of the present invention may as well be provided in the first case having the constitution to be conducted with electronic instruments and in the second case having the constitution to be earthed. As such, the joining device can bias respectively the vicinities of free ends of the first and second cases in the direction of contacting these vicinities with each other. With this constitution, mere attachment of the first case to the second case allows electronic instruments to be earthed, that is, electronic instruments can be easily earthed.

The joining device of the present invention can be applied to any constitution being such that attaching the first and second members by means of the attachment member involves contacting with each other respective vicinities of free ends movable in the direction intersecting that of attachment of the first and second members.

The constitution of the rib portions 125, 211 and the engagement portions 136, 220 are not limited to each constitution described above, and may as well be any other appropriate constitution having the upper side plate portion 122 being biased in the contact direction.

A specific constitution when implementing the present invention may be altered to another constitution as appropriate insofar as the objects of the present invention are achievable. The disc apparatus equipped with the joining device of the present invention can have benefits of the effects of the present invention.

[Effects of Embodiments]

As described above, the first embodiment contemplates providing the rib portion 125 at the upper side plate portion 122 of the upper case 120 of the disc apparatus 100. Further, the lower side plate portion 132 of the lower case to be attached to with the upper case 120 is provided with the engagement portion 136, which biases the upper side plate portion 122 in the contact direction when engaging the rib portion 125 with the lower side plate portion 132 of the lower case 130 having the upper case 120 to be attached thereto. As such, a simple constitution of merely providing the rib portion 125 and the engagement portion 136, which have the above-described functions, respectively on the upper and lower cases 120 and 130, and attaching the upper case 120 to the lower case 130, enables the upper side plate portion 122 to be biased in the contact direction and so allows the upper side plate portion 122 to be easily contacted to the lower side plate portion 132.

Further, it is constituted such that the rib contact portion 127 of the rib portion 125 slopes with respect to the direction of engaging the rib portion 125 and the engagement portion 136 with each other and to that of contacting the upper side plate portion 122 and the lower side plate portion 132 with each other. As such, the upper side plate portion 122 connected to the rib portion 125 is guided in the contact direction by the above-described reaction force which is applied onto the rib contact portion 127 when engaging the rib portion 125 and the engagement portion 136 with each other. When the upper case 120 is attached to the lower case 130 with the rib portion 125 and the engagement portion 136 engaging each other, this causes the upper side plate portion 122 to be biased in the contact direction with the load W10. Therefore, a simple constitution of merely making the rib contact portion 127 of the rib portion 125 slope with respect to the direction of engaging the rib portion 125 and the engagement portion 136 with each other and to that of contacting the upper side plate portion 122 and the lower side plate portion 132 with each other, enables the upper side plate portion 122 to be biased in the contact direction and so allows the upper side plate portion 122 to be easily contacted to the lower side plate portion 132.

The priority application Number JP 2004-028094 upon which this patent application is based is hereby incorporated by reference.

1. A joining device including a first and a second member to be attached by means of an attachment member, respective vicinities of movable free ends of the first and the second members being contacted with each other, comprising:
an engagement portion provided on one of the first and the second members; and
a lock portion for biasing at least one of the vicinities of the free ends of the first and the second members, through engagement with the engagement portion, in the direction of contacting with each other, the lock portion being provided at the other one of the first and the second members.

2. The joining device according claim 1, wherein:
each free end of the first and the second members is movable in the direction intersecting an attachment direction.

3. The joining device according to claim 1, wherein:
the engagement portion and the lock portion are disposed at a position spaced apart from a location attached by means of the attachment member at the each free end of the first and the second members.

4. The joining device according to claim 1, wherein:
at least one of the engagement portion and the lock portion is provided with a slope portion sloping with respect to the direction of the engaging and the direction of the contacting.

5. A joining device including a first member and a second member to be attached by means of an attachment member, respective vicinities of free ends, which are movable in the direction intersecting an attachment direction, of the first and the second members being contacted with each other, comprising:
an engagement portion provided at one of the vicinities of the free ends of the first and the second members; and
a lock portion for engaging with the engagement portion, the lock portion being provided at the other one of the vicinities of the free ends of the first and the second members; wherein:
at least one of the engagement portion and the lock portion is provided with a slope portion sloping with respect to the direction of the engaging and the direction of the contacting.

6. The joining device according to claim 4, wherein:
the slope portion is provided at the lock portion; and
the slope of the slope portion with respect to the direction of the engaging on the side of the front end in the direction of the engaging is made to be steeper than the slope of the slope portion with respect to the direction of the engaging on the side of the proximal end in the direction of the engaging.

7. The joining device according to claim 5, wherein:
the slope portion is provided at the lock portion; and
the slope of the slope portion with respect to the direction of the engaging on the side of the front end in the direction of the engaging is made to be steeper than the slope of the slope portion with respect to the direction of the engaging on the side of the proximal end in the direction of the engaging.

8. The joining device according to claim 1, wherein:
at least one of the engagement portion and the lock portion is elastically deformable in the state engaged with each other, and the vicinities of the free ends of the first and the second members are biased, by means of the restoring force against its elastic deformation in the direction of contacting vicinities of the free ends with each other.

9. The joining device according to claim 5, wherein:
at least one of the engagement portion and the lock portion is elastically deformable in the state engaged with each other, and the vicinities of the free ends of the first and the second members are biased, by means of the restoring force against its elastic deformation in the direction of contacting vicinities of the free ends with each other.

10. The joining device according to claim 1, wherein:
at least one of the engagement portion and the lock portion is provided on a free edge of at least one of the first and the second members.

11. The joining device according to claim 5, wherein:
at least one of the engagement portion and the lock portion is provided on a free edge of at least one of the first and the second members.

12. The joining device according to claim 1, wherein:
the lock portion is formed by cutting and raising a tongue shape whose front end in the direction of the engaging becomes a free end.

13. The joining device according to claim 5, wherein:
the lock portion is formed by cutting and raising a tongue shape whose front end in the direction of the engaging becomes a free end.

14. The joining device according to claim 12, wherein:
the engagement portion has an opening portion, into which the lock portion is inserted, whereupon engagement is provided in the state of the engagement portion being contacted with the opening edge of the opening portion.

15. The joining device according to claim 13, wherein:
the engagement portion has an opening portion, into which the lock portion is inserted, whereupon engagement is provided in the state of the engagement portion being contacted with the opening edge of the opening portion.

16. The joining device according to claim 14, wherein:
the engagement portion is of a generally tubular shape whose axial direction is approximately parallel to the direction of the direction of the attaching.

17. The joining device according to claim 15, wherein:
the engagement portion is of a generally tubular shape whose axial direction is approximately parallel to the direction of the direction of the attaching.

18. The joining device according to claim 1, wherein:
the first member is a first case with at least one face being open;
the second member is a second case adapted to close the at least one face being open in the first case; and
the first and the second members substantially define a vibratory apparatus storage space for storing a vibrating vibratory apparatus when attached by means of the attachment member with the at least one face being closed.

19. The joining device according to claim 5, wherein:
the first member is a first case with at least one face being open;
the second member is a second case adapted to close the at least one face being open in the first case; and
the first and the second members substantially define a vibratory apparatus storage space for storing a vibrating vibratory apparatus when attached by means of the attachment member with the at least one face being closed.

20. The joining device according to claim 1, wherein:
the first member is a first case electrically conductive with the at least one face being open;
the second member is a second case being electrically conductive being adapted to close the at least one face being open in the first member; and
the first and the second members substantially define an electronic instrument storage space for storing electronic instruments when attached by means of the attachment member with the at least one face being closed.

21. The joining device according to claim 5, wherein:
the first member is a first case electrically conductive with the at least one face being open;
the second member is a second case being electrically conductive being adapted to close the at least one face being open in the first member; and
the first and the second members substantially define an electronic instrument storage space for storing electronic instruments when attached by means of the attachment member with the at least one face being closed.

22. The joining device according to claim 20, wherein:
either one of the first and the second members is configured such that there is made conductive the electronic equipments to be stored in the electronic instrument storage space; and the other one of the first and the second members is to be grounded.

23. The joining device according to claim 21, wherein:
either one of the first and the second members is configured such that there is made conductive the electronic equipments to be stored in the electronic instrument storage space; and the other one of the first and the second members is to be grounded.
